(19) United States
(12) Patent Application Publication
(10) Pub. No.: US 2021/0358351 A1
(43) Pub. Date: Nov. 18, 2021

(54) COMBINED DISPLAY PANEL

(71) Applicant: Shenzhen China Star Optoelectronics Semiconductor Display Technology Co., Ltd., Shenzhen, Guangdong (CN)

(72) Inventor: Baixiang Han, Shenzhen, Guangdong (CN)

(21) Appl. No.: 16/608,601

(22) PCT Filed: Sep. 11, 2019
(86) PCT No.: PCT/CN2019/105314

§ 371 Date: Oct. 25, 2019

(30) Foreign Application Priority Data
May 7, 2019 (CN) 201910374231.1

(51) Int. Cl. G09G 3/00; H04N 13/305

(52) U.S. Cl. CPC G09G 3/003; H04N 13/305; G09G 2354/00; G09G 2300/0452; G09G 2300/023

(57) ABSTRACT

A combined display panel comprising N sub-displays which are overlapped, wherein N is a positive integer greater than or equal to 2. Wherein each sub-display includes a plurality of sub-display units, a plurality of sub-display units correspondingly disposed in a same group constitute a display unit of the combined display panel. Each sub-display unit of each display unit includes a pixel region and a transparent region.

### BACKGROUND OF INVENTION

### Field of Invention

The present invention relates to the field of electronic display, and in particular, to a combined display panel.

### Description of Prior Art

Current naked eye 3D technology mainly includes a light barrier technology and a lenticular lens technology.

Principle of the light barrier technology is to use a liquid crystal layer and a polarizing film to produce a series of vertical stripes with a 90° direction. Width between these stripes are tens of microns and the light through them forms a vertical strip raster. The strip raster can separate a visible image entering left and right eyes, allowing user to see the 3D image. The advantages of light barrier technology are low cost and easy mass production.

The lenticular lens technology is also known as microcolumn lens 3D technology, in which a row of columnar lenses are attached in front of a liquid crystal display screen so that an image plane of the liquid crystal panel is located on the focal plane of the lens. At the same time, pixels of the image under each cylindrical lens are divided into several sub-pixels, and the lens projects each sub-pixel in a different direction. Because angles between user's eyes and the display screen are different, the visible images entering the left and right eyes of the user are separated, allowing the user to see the 3D image.

### Technical Problems

The 3D image obtained using the light barrier technology has lower resolution and brightness, and its user experience is poor. The lenticular lens technology optimizes the brightness of the screen, which is better than the 3D image obtained by the light barrier technology. However, the application of the lens causes a certain distortion of the image and does not improve the resolution of the 3D image.

### SUMMARY OF INVENTION

The present application provides a combined display panel to improve the resolution and brightness of a naked-eye 3D display.

In order to solve the above problems, the present application provides a combined display panel comprising N sub-displays which are overlapped, wherein N is a positive integer greater than or equal to 2,

wherein each sub-display comprises a plurality of sub-display units, projections of sub-display units of any two sub-displays on a light-emitting surface of the combined display panel overlap, a plurality of sub-display units correspondingly disposed in a same group constitute a display unit of the combined display panel;

wherein each sub-display unit of each display unit comprises a pixel region and a transparent region, projections of pixel regions of the of sub-display units on the light-emitting surface of the combined display panel completely covers the light-emitting surface of the display unit;

wherein the combined display panel further comprises a picture processor and a signal transmission unit;

wherein the picture processor divides a picture to be displayed into N bit planes according to display content to ensure display objects having a same field depth are displayed on a same sub-display;

wherein the signal transmission unit comprises N sub-transmission units which are in one-to-one correspondence with the N sub-displays, each sub-transmission unit transmits information of object to be displayed to the corresponding sub-display according to an instruction of the picture processor.

According to an aspect of the application, wherein projections of the pixel regions of each sub-display units on the light-emitting surface of the combined display panel separates from each other.

According to an aspect of the application, wherein an area of each of the pixel regions is equal to 1/N of an area of the sub-display unit, and regions outside the pixel regions are transparent regions.

According to an aspect of the application, wherein the N sub-displays have same area, shape and thickness, projections of the N sub-displays on the light-emitting surface of the combined display panel completely overlap.

According to an aspect of the application, wherein a distance between adjacent two sub-displays is equal.

According to an aspect of the application, wherein each pixel region comprises at least one red pixel, at least one green pixel, and at least one blue pixel.

In order to solve the above problems, the present application provides a combined display panel comprising N sub-displays which are overlapped, wherein N is a positive integer greater than or equal to 2;

wherein each sub-display comprises a plurality of sub-display units, projections of sub-display units of any two sub-displays on a light-emitting surface of the combined display panel overlap, a plurality of sub-display units correspondingly disposed in a same group constitute a display unit of the combined display panel;

wherein each sub-display unit of each display unit comprises a pixel region and a transparent region, projections of pixel regions of the of sub-display units on the light-emitting surface of the combined display panel completely covers the light-emitting surface of the display unit.

According to an aspect of the application, wherein projections of the pixel regions of each sub-display units on the light-emitting surface of the combined display panel separates from each other.

According to an aspect of the application, wherein an area of each of the pixel regions is equal to 1/N of an area of the sub-display unit, and regions outside the pixel regions are transparent regions.

According to an aspect of the application, wherein the N sub-displays have same area, shape and thickness, projections of the N sub-displays on the light-emitting surface of the combined display panel completely overlap.

According to an aspect of the application, wherein a distance between adjacent two sub-displays is equal.

According to an aspect of the application, wherein each pixel region comprises at least one red pixel, at least one green pixel, and at least one blue pixel.

According to an aspect of the application, wherein the combined display panel further comprises a picture processor and a signal transmission unit;

wherein the picture processor divides a picture to be displayed into N bit planes according to display content to ensure display objects having a same field depth are displayed on a same sub-display;

wherein the signal transmission unit comprises N sub-transmission units which are in one-to-one correspondence with the N sub-displays, each sub-transmission unit transmits information of object to be displayed to the corresponding sub-display according to an instruction of the picture processor.

According to an aspect of the application, wherein a distance between an object in a picture and the light-emitting surface of the combined display panel is proportional to a field depth of the object.

According to an aspect of the application, wherein the number N of the sub-displays is two.

According to an aspect of the application, wherein the number N of the sub-displays is four.

According to an aspect of the application, wherein the combined display panel further comprises a human eye detector and an image processor;

the human eye detector is configured to acquire positions of a left eye and a right eye of a user;

the image processor is configured to divide a display screen of the combined display panel into two groups according to the positions of the left eye and the right eye of the user, and input into the left eye and the right eye of the user respectively.

According to an aspect of the application, wherein the human eye detector is a plurality of cameras uniformly distributed on the combined display panel and an information processor corresponding to the plurality of cameras.

According to an aspect of the application, wherein the image processor is a slit grating covering the light-emitting surface of the combined display panel.

According to an aspect of the application, wherein the image processor is a plurality of lenticular lenses covering the light-emitting surface of the combined display panel.

### BENEFICIAL EFFECTS

The combined display panel provided by the present application has a plurality of sub-displays arranged in an overlapping manner, and display unit of the combined display panel is composed of pixel regions in a plurality of correspondingly disposed sub-display screens complement each other. Because pixel regions in a same display unit are respectively disposed on different display sub-displays, the screen displayed by the combined display panel in the present application has a certain field depth effect. Three-dimensional display can be realized by projecting objects to be displayed on different sub-displays according to the range of field depth. Compared with the naked eye 3D technology in the prior art, the present application can realize 3D display without dividing the display screen of the display panel, and avoids light loss and screen deformation, thereby achieve a good display effect.

### BRIEF DESCRIPTION OF DRAWINGS

FIG. 1 is a structural diagram of a first sub-display screen in a specific embodiment of the present application.

FIG. 2 is a structural diagram of a second sub-display screen in an embodiment of the present application.

FIG. 3 is a structural diagram of a combined display panel composed of a first sub-display screen and a second sub-display screen in FIG. 1 and FIG. 2.

FIG. 4 is a structural diagram of a first sub-display screen in another embodiment of the present application.

FIG. 5 is a structural diagram of a second sub-display screen in another embodiment of the present application.

FIG. 6 is a structural diagram of a third sub-display screen in another embodiment of the present application.

FIG. 7 is a structural diagram of a fourth sub-display screen according to another embodiment of the present application.

FIG. 8 is a structural diagram of a combined display panel composed of the first sub-display screen, the second sub-display screen, the third sub-display screen, and the fourth sub-display screen in FIG. 4 to FIG. 7.

### DETAILED DESCRIPTION OF PREFERRED EMBODIMENTS

Description of following embodiment, with reference to accompanying drawings, is used to exemplify specific embodiments which may be carried out in the present disclosure. Directional terms mentioned in the present disclosure, such as “top”, “bottom”, “front”, “back”, “left”, “right”, “inside”, “outside”, “side”, etc., are only used with reference to orientation of the accompanying drawings. Therefore, the directional terms are intended to illustrate, but not to limit, the present disclosure. In the drawings, components having similar structures are denoted by same numerals.

The present application provides a combined display panel comprising N sub-displays which are overlapped, wherein N is a positive integer greater than or equal to 2. Each sub-display comprises a plurality of sub-display units, projections of sub-display units of any two sub-displays on a light-emitting surface of the combined display panel overlap, a plurality of sub-display units correspondingly disposed in a same group constitute a display unit of the combined display panel. Each sub-display unit of each display unit comprises a pixel region and a transparent region, projections of pixel regions of the of sub-display units on the light-emitting surface of the combined display panel completely covers the light-emitting surface of the display unit.

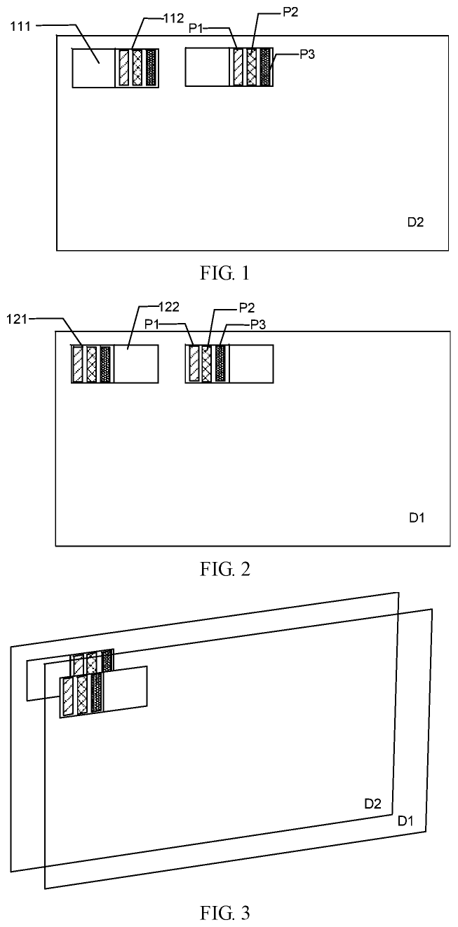

FIG. 1, FIG. 2 and FIG. 3 show the first embodiment of the present application, FIG. 1 is a structural diagram of a first sub-display screen in a specific embodiment of the present application, FIG. 2 is a structural diagram of a second sub-display screen in an embodiment of the present application, FIG. 3 is a structural diagram of a combined display panel composed of a first sub-display screen and a second sub-display screen in FIG. 1 and FIG. 2.

In this embodiment, N is equal to 2, and the display panel includes a first sub-display screen D1 and a second sub-display screen D2. The first sub-display screen D1 and the second sub-display screen D2 each include a plurality of sub-display units. Projections of the plurality of sub-display units of the first sub-display panel D1 and the plurality of sub-display units of the second sub-display panel D2 on a light-emitting surface of the combined display panel overlap. A plurality of sub-display units correspondingly disposed in a same group constitute a display unit of the combined display panel. Each the sub-display unit of the first sub-display screen D1 includes a pixel region 111 and a transparent region 112. Each sub-display unit of the second sub-display screen D2 includes a pixel region 121 and a transparent region 122. Projections of the pixel region 111 of the first sub-display screen D1 and the pixel region 121 of the second sub-display screen D2 on a light-emitting surface of the combined display panel completely covers the light-emitting surface of the display unit.

In this embodiment, projections of the pixel region 111 of the first sub-display screen D1 separates from the pixel region 121 of the second sub-display screen D2 on the light-emitting surface of the combined display panel. An area of the pixel region 111 and an area the pixel region 121 are equal and equal to ½ of an area of the display subunit.

In this embodiment, the two sub-display screens have a same area, shape and thickness, and projections of the two sub-display screens on the light-emitting surface of the combined display panel completely overlap. After overlapping, the projections of the pixel region 111 of the first sub-display screen D1 and the pixel region 121 of the second sub-display screen D2 on the light-emitting surface of the combined display panel completely covers the display unit. Light emitted by the pixel region 121 of the second sub-display screen D2 can reach the light-emitting surface of the combined display panel through the transparent region 112 of the first sub-display screen D1. Because there is a fixed interval between the first sub-display D1 and the second sub-display D2, a certain field depth exists between the display screen of the first sub-display screen D1 and the display screen of the second sub-display screen D2, and 3D display can be realized without dividing the screen.

In the present application, each pixel region includes at least one red pixel point P1, at least one green light pixel point P2, and at least one blue light pixel point P3. For a display panel of a same area, the smaller a number of pixels included in the pixel region, the more a number of display units, the more accurate a separation of the first sub-display D1 and the second sub-display D2 is, and the better the 3D effect is. Therefore, in this embodiment, each pixel region includes one red pixel point P1, one green light pixel point P2, and one blue light pixel point P3.

In the present application, the combined display panel further comprises a picture processor and a signal transmission unit. Wherein the picture processor divides a picture to be displayed into two bit planes according to display content to ensure display objects having a same field depth are displayed on a same sub-display. Wherein the signal transmission unit comprises two sub-transmission units which are in one-to-one correspondence with the two sub-displays, each sub-transmission unit transmits information of object to be displayed to the corresponding sub-display according to an instruction of the picture processor. A distance between an object in a picture and the light-emitting surface of the combined display panel is proportional to a field depth of the object.

In this embodiment, the picture processor divides a picture to be displayed into two bit planes according to display content, so that display objects having a small field depth is displayed on the first sub-display D1, and display object having a larger depth of field is displayed on the second sub-display D2. Picture on the second sub-display screen D2 emits from the transparent region of the first display screen D1. Because the interval between the first sub-display screen D1 and the second sub-display screen D2 is fixed, the screen displayed by the combined display panel naturally has a depth of field effect without producing light on the display panel to get a 3D effect. Compared with the naked eye 3D technology in the prior art, the application avoids light loss and picture deformation, achieve a good display effect.

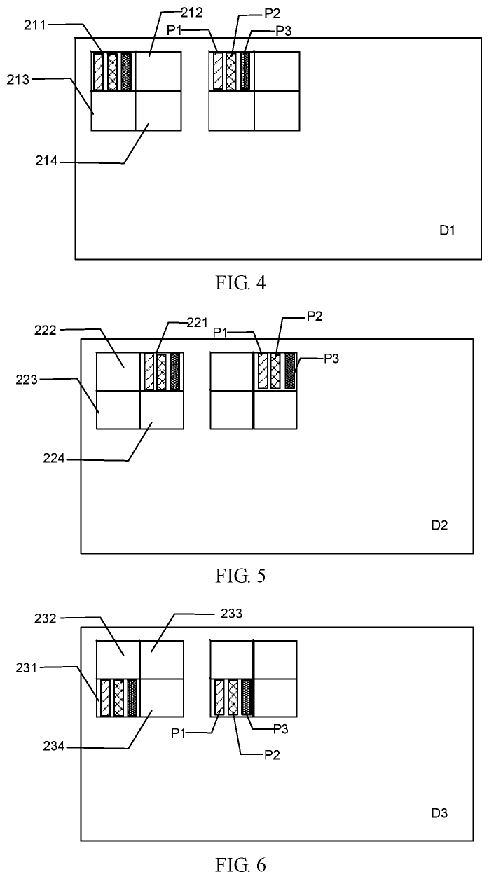

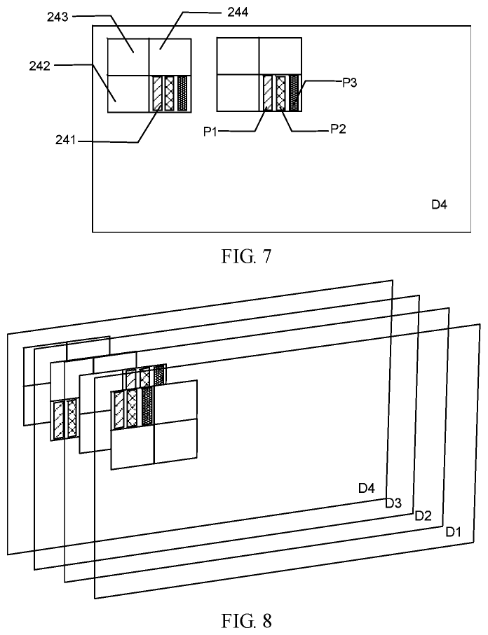

FIG. 4 to FIG. 8 show the first embodiment of the present application, FIG. 4 is a structural diagram of a first sub-display screen in another embodiment of the present application. FIG. 5 is a structural diagram of a second sub-display screen in another embodiment of the present application. FIG. 6 is a structural diagram of a third sub-display screen in another embodiment of the present application. FIG. 7 is a structural diagram of a fourth sub-display screen according to another embodiment of the present application. FIG. 8 is a structural diagram of a combined display panel composed of the first sub-display screen, the second sub-display screen, the third sub-display screen, and the fourth sub-display screen in FIG. 4 to FIG. 7.

In this embodiment, N is equal to 4, and the display panel includes a first sub-display D1, a second sub-display D2, a third sub-display D3, and a fourth sub-display D4. The first sub-display D1, the second sub-display D2, the third sub-display D3, and the fourth sub-display D4 each include a plurality of sub-display units. Projections of the plurality of sub-display units of the first sub-display screen D1, the plurality of sub-display units of the second sub-display screen D2, the plurality of sub-display units of the third sub-display screen D3, and the plurality of sub-display units of the fourth sub-display screen D4 overlap on the light-emitting surface of the combined display panel. A plurality of sub-display units correspondingly disposed in a same group constitute a display unit of the combined display panel. Each sub-display unit includes a pixel region and a transparent region. And projections of a pixel region 211 of the first sub-display screen D1, a pixel region 212 of the second sub-display screen D2, a pixel region 213 of the third sub-display screen D3, and a pixel region 214 of the fourth sub-display screen D4 on the light-emitting surface of the combined display panel completely covers the light-emitting surface of the display unit.

In this embodiment, projections of a pixel region 211 of the first sub-display screen D1, a pixel region 212 of the second sub-display screen D2, a pixel region 213 of the third sub-display screen D3, and a pixel region 214 of the fourth sub-display screen D4 on the light-emitting surface of the combined display panel separates from each other. Areas of the pixel area 211, the pixel area 212, the pixel area 213, and the pixel area 214 are equal and equal to ¼ of the area of the sub-display unit. The area outside the pixel region is a transparent region.

In this embodiment, the transparent regions of the first sub-display screen D1 include a first transparent region 221, a second transparent region 231, and a third transparent region 241. The first transparent region 221, the second transparent region 231, and the third transparent region 241 respectively correspond to the pixel region 212 of the second sub-display screen D2, the pixel region 213 of the third sub-display screen D3, and a pixel region 214 of the fourth sub-display screen D4.

In this embodiment, the transparent regions of the second sub-display screen D2 include a first transparent region 222, a second transparent region 232, and a third transparent region 242. The first transparent region 222, the second transparent region 232, and the third transparent region 242 respectively correspond to the pixel region 211 of the first sub-display screen D1, the pixel region 213 of the third sub-display screen D3, and a pixel region 214 of the fourth sub-display screen D4. The light emitted by the pixel region 212 of the second sub-display screen D2 can reach the light-emitting surface of the combined display panel through the transparent regions of the first sub-display screen D1.

In this embodiment, the transparent regions of the third sub-display screen D3 include a first transparent region 223, a second transparent region 233, and a third transparent region 243. The first transparent region 223, the second transparent region 233, and the third transparent region 243 respectively correspond to the pixel region 211 of the first sub-display screen D1, the pixel region 212 of the second sub-display screen D2, and a pixel region 214 of the fourth sub-display screen D4. The light emitted by the pixel region 213 of the third sub-display screen D3 can reach the light-emitting surface of the combined display panel through the transparent regions of the first sub-display screen D1 and the second sub-display screen D2.

In this embodiment, the transparent regions of the fourth sub-display screen D4 include a first transparent region 224, a second transparent region 234, and a third transparent region 244. The first transparent region 224, the second transparent region 234, and the third transparent region 244 respectively correspond to the pixel region 211 of the first sub-display screen D1, the pixel region 212 of the second sub-display screen D2, and the pixel region 213 of the third sub-display screen D3. The light emitted by the pixel region 214 of the fourth sub-display screen D4 can reach the light-emitting surface of the combined display panel through the transparent regions of the first sub-display screen D1, the second sub-display screen D2 and the third sub-display screen D3.

In this embodiment, the first sub-display D1, the second sub-display D2, the third sub-display D3, and the fourth sub-display D4 have same area, shape and thickness, projections of the first sub-display D1, the second sub-display D2, the third sub-display D3, and the fourth sub-display D4 on the light-emitting surface of the combined display panel completely overlap.

Because there is a fixed interval between the first sub-display D1, the second sub-display D2, the third sub-display D3, and the fourth sub-display D4, a certain field depth exists between the display screen of the first sub-display screen D1 and the display screen of the second sub-display screen D2, and 3D display can be realized without dividing the screen. In this embodiment, intervals between the first sub-display D1, the second sub-display D2, the third sub-display D3, and the fourth sub-display D are equal.

In the present application, each pixel region includes at least one red pixel point P1, at least one green light pixel point P2, and at least one blue light pixel point P3. For a display panel of a same area, the smaller a number of pixels included in the pixel region, the more a number of display units, the more accurate a separation of the first sub-display D1 and the second sub-display D2 is, and the better the 3D effect is. Therefore, in this embodiment, each pixel region includes one red pixel point P1, one green light pixel point P2, and one blue light pixel point P3.

In this embodiment, the combined display panel further comprises a picture processor and a signal transmission unit. The picture processor divides a picture to be displayed into four bit planes according to display content to ensure display objects having a same field depth are displayed on a same sub-display. The signal transmission unit comprises four sub-transmission units which are in one-to-one correspondence with the four sub-displays, each sub-transmission unit transmits information of object to be displayed to the corresponding sub-display according to an instruction of the picture processor. A distance between an object in a picture and the light-emitting surface of the combined display panel is proportional to a field depth of the object.

In this embodiment, the picture processor divides a picture to be displayed into four bit planes according to display content, so that display objects having a smallest field depth is displayed on the first sub-display D1, display objects having a smaller field depth is displayed on the first sub-display D2, display object having a larger depth of field is displayed on the second sub-display D3, and display object having a largest depth of field is displayed on the second sub-display D4. Because the intervals between he first sub-display D1, the second sub-display D2, the third sub-display D3, and the fourth sub-display D4 are fixed, the screen displayed by the combined display panel naturally has a depth of field effect without producing light on the display panel to get a 3D effect. Compared with the naked eye 3D technology in the prior art, the application avoids light loss and picture deformation, achieve a good display effect.

It should be noted that the number of sub-display screens in the present application is not limited to two or four described in the above embodiments, and could also be three, five or more. The above embodiments are only used to illustrate the present application and are not to be construed as limiting the present application.

As is understood by persons skilled in the art, the foregoing preferred embodiments of the present disclosure are illustrative rather than limiting of the present disclosure. It is intended that they cover various modifications and that similar arrangements be included in the spirit and scope of the present disclosure, the scope of which should be accorded the broadest interpretation so as to encompass all such modifications and similar structures.

What is claimed is:

1. A combined display panel comprising N sub-displays which are overlapped, wherein N is a positive integer greater than or equal to 2;
wherein each sub-display comprises a plurality of sub-display units, projections of sub-display units of any two sub-displays on a light-emitting surface of the combined display panel overlap, a plurality of sub-display units correspondingly disposed in a same group constitute a display unit of the combined display panel;
wherein each sub-display unit of each display unit comprises a pixel region and a transparent region, projections of pixel regions of the of sub-display units on the light-emitting surface of the combined display panel completely covers the light-emitting surface of the display unit;
wherein the combined display panel further comprises a picture processor and a signal transmission unit;
wherein the picture processor divides a picture to be displayed into N bit planes according to display content to ensure display objects having a same field depth are displayed on a same sub-display;
wherein the signal transmission unit comprises N sub-transmission units which are in one-to-one correspondence with the N sub-displays, each sub-transmission unit transmits information of object to be displayed to the corresponding sub-display according to an instruction of the picture processor.

2. The combined display panel according to claim 1, wherein projections of the pixel regions of each sub-display units on the light-emitting surface of the combined display panel separates from each other.

3. The combined display panel according to claim 2, wherein an area of each of the pixel regions is equal to 1/N of an area of the sub-display unit, and regions outside the pixel regions are transparent regions.

4. The combined display panel according to claim 1, wherein the N sub-displays have same area, shape and thickness, projections of the N sub-displays on the light-emitting surface of the combined display panel completely overlap.

5. The combined display panel according to claim 4, wherein a distance between adjacent two sub-displays is equal.

6. The combined display panel according to claim 1, wherein each pixel region comprises at least one red pixel, at least one green pixel, and at least one blue pixel.

7. A combined display panel comprising N sub-displays which are overlapped, wherein N is a positive integer greater than or equal to 2;
wherein each sub-display comprises a plurality of sub-display units, projections of sub-display units of any two sub-displays on a light-emitting surface of the combined display panel overlap, a plurality of sub-display units correspondingly disposed in a same group constitute a display unit of the combined display panel;
wherein each sub-display unit of each display unit comprises a pixel region and a transparent region, projections of pixel regions of the of sub-display units on the light-emitting surface of the combined display panel completely covers the light-emitting surface of the display unit.

8. The combined display panel according to claim 7, wherein projections of the pixel regions of each sub-display units on the light-emitting surface of the combined display panel separates from each other.

9. The combined display panel according to claim 8, wherein an area of each of the pixel regions is equal to 1/N of an area of the sub-display unit, and regions outside the pixel regions are transparent regions.

10. The combined display panel according to claim 7, wherein the N sub-displays have same area, shape and thickness, projections of the N sub-displays on the light-emitting surface of the combined display panel completely overlap.

11. The combined display panel according to claim 10, wherein a distance between adjacent two sub-displays is equal.

12. The combined display panel according to claim 7, wherein each pixel region comprises at least one red pixel, at least one green pixel, and at least one blue pixel.

13. The combined display panel according to claim 7, wherein the combined display panel further comprises a picture processor and a signal transmission unit;
wherein the picture processor divides a picture to be displayed into N bit planes according to display content to ensure display objects having a same field depth are displayed on a same sub-display;
wherein the signal transmission unit comprises N sub-transmission units which are in one-to-one correspondence with the N sub-displays, each sub-transmission unit transmits information of object to be displayed to the corresponding sub-display according to an instruction of the picture processor.

14. The combined display panel according to claim 13, wherein a distance between an object in a picture and the light-emitting surface of the combined display panel is proportional to a field depth of the object.

15. The combined display panel according to claim 7, wherein the number N of the sub-displays is two.

16. The combined display panel according to claim 7, wherein the number N of the sub-displays is four.

17. The combined display panel according to claim 7, wherein the combined display panel further comprises a human eye detector and an image processor;
the human eye detector is configured to acquire positions of a left eye and a right eye of a user;
the image processor is configured to divide a display screen of the combined display panel into two groups according to the positions of the left eye and the right eye of the user, and input into the left eye and the right eye of the user respectively.

18. The combined display panel according to claim 17, wherein the human eye detector is a plurality of cameras uniformly distributed on the combined display panel and an information processor corresponding to the plurality of cameras.

19. The combined display panel according to claim 17, wherein the image processor is a slit grating covering the light-emitting surface of the combined display panel.

20. The combined display panel according to claim 17, wherein the image processor is a plurality of lenticular lenses covering the light-emitting surface of the combined display panel.
